(19) United States
(12) Patent Application Publication
(10) Pub. No.: US 2009/0089393 A1
(43) Pub. Date: Apr. 2, 2009

(54) SYSTEM AND METHOD FOR MANAGING DATA DOWNLOADS AND DATA UPLOADS

(75) Inventor: QI YI, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 11/967,048

(22) Filed: Dec. 29, 2007

(30) Foreign Application Priority Data
Sep. 28, 2007 (CN) 200710201890.2

(51) Int. Cl. G06F 15/167

(52) U.S. Cl. 709/211

(57) ABSTRACT

An exemplary method for managing data downloads and data uploads is provided. The method includes: searching a target slave terminal from a plurality of linked slave terminals, and identifying the target slave terminal from other linked slave terminals by a MAC address; establishing a secure connection between at least one linked master terminal and the target slave terminal; setting task parameters of the target slave terminal; sending a task request to the target slave terminal; performing data downloads or data uploads according to the task request from the at least one linked master terminal; reporting download/upload progresses of the target slave terminal to the linked master terminal according to the task parameters; and saving downloaded data in a file. A related system is also provided.

### BACKGROUND OF THE INVENTION

1. Field of the Invention

The present invention relates to systems and methods for managing data via networks, and more particularly to a system and method for managing data downloads and data uploads.

2. Description of Related Art

As compared to before, there are more means and methods for data transfer between devices over networks. A common method nowadays is to share data over the Internet using BitTorrent (BT). BT is a peer-to-peer download software, which overcomes the limitations of traditional download mode. Its main feature is: the more people download, the faster the data will be downloaded. However, in order to implement BT, because data is stored separately among all the devices, all the devices holding the data must be kept power-on, thus wasting power.

Based on the above reasons, embedded devices have appeared in a network technology. The embedded devices has resulted in new problems, for example, the embedded devices are not configured with keyboards, mice or screens, the user needs to control the embedded device to download or upload data via a Web method or commands. Furthermore, if the user wants to download data via the network, the client needs to manually copy corresponding Websites of the data one by one, and then transmits them to the embedded device for data downloads. This method is complicated and uneasy to perform.

What is needed, therefore, is a system and method for managing data downloads and data uploads, which can simplify flows of data downloads or data uploads.

### SUMMARY OF THE INVENTION

A system for managing data downloads and data uploads is disclosed. The system includes at least one linked master terminal and a plurality of linked slave terminals connected to the at least one linked master terminal via a network. The at least one linked master terminal is configured with a proxy program. The proxy program includes: a searching module configured for searching one of the linked slave terminals via the network, and identifying a target slave terminal from other linked slave terminals by a MAC address; a secure connecting module configured for establishing a secure connection between the target slave terminal and the at least one linked master terminal; and a data download/upload managing module configured for sending a task request to the target slave terminal. The task request includes a data download request and a data upload request. The target slave terminal is configured with a business program. The business program includes: a setting module configured for setting task parameters of the target slave terminal, the task parameters comprising an operating status; and a data transfer module configured for performing data downloads or data uploads according to the task request, reporting download/upload progresses according to the operating status, and saving downloaded data in a file.

A computer-enabled method for managing data downloads and data uploads includes: providing at least one linked master terminal connecting with a plurality of linked slave terminals via a network; searching one of the linked slave terminals, and identifying a target slave terminal from other linked slave terminals by a MAC address; establishing a secure connection between the at least one linked master terminal and the target slave terminal; setting task parameters of the target slave terminal through the at least one linked master terminal, the task parameters comprising an operating status; sending a task request to the target slave terminal, the task request comprising a data download request and a data upload request; performing data downloads or data uploads according to the task request from the at least one linked master terminal; reporting download/upload progresses of the target slave terminal to the linked master terminal according to the operating status; and saving downloaded data in a file.

Other novel features of the indicated invention will become more apparent from the following detailed description of the preferred embodiment when taken in conjunction with the accompanying drawings.

### BRIEF DESCRIPTION OF THE DRAWINGS

FIG. 1 is a schematic diagram of a system for managing data downloads and data uploads in accordance with one embodiment.

FIG. 2 is a schematic diagram of software function modules of a proxy program and a business program of FIG. 1.

FIG. 3 is a flowchart of a preferred method for managing data downloads and data uploads in accordance with another embodiment.

### DETAILED DESCRIPTION OF THE INVENTION

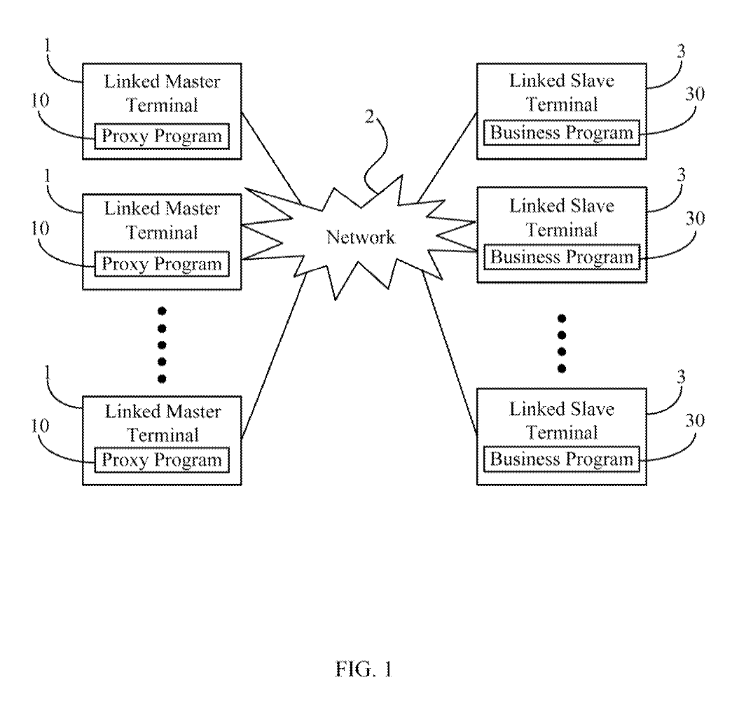

FIG. 1 is a schematic diagram of a system for managing data downloads and data uploads (hereinafter, “the system”) in accordance with a preferred embodiment. The system typically includes at least one linked master terminal 1, and a plurality of linked slave terminals 3 that connects with the at least one linked master terminal 1 via a network 2. The at least one linked master terminal 1 may be a desktop computer, a laptop computer, a notebook, or a mobile telephone. The linked slave terminals 3 are selected from the group of desktop computers, laptop computers, notebooks, mobile telephones, or any other type of low-powered embedded-system devices, which are embedded devices. The network 2 is a conventional electronic communication network, which can be the intranet, the Internet or any other suitable networks that can transfer data.

In the preferred embodiment, the at least one linked master terminal 1 is installed with a proxy program 10, and is configured for controlling the linked slave terminals 3 to download or upload data by utilizing the proxy program 10. The proxy program 10 is composed of data and codes that are edited by a first computer programming language, for example, a java language.

Each of the linked slave terminals 3 is installed with a business program 30, and is configured for downloading and uploading data by utilizing the business program 30. The business program 30 is also composed of data and codes that are edited by a second computer programming language, which is different from the first computer programming language of the proxy program, such as “C” or “C++”. The proxy program 10 obtains operating status of each of the linked slave terminals 3 through the business program 30. For example, the proxy program 10 queries data transfer speeds or download/upload progresses of the linked slave terminals 3 by utilizing the business program 30.

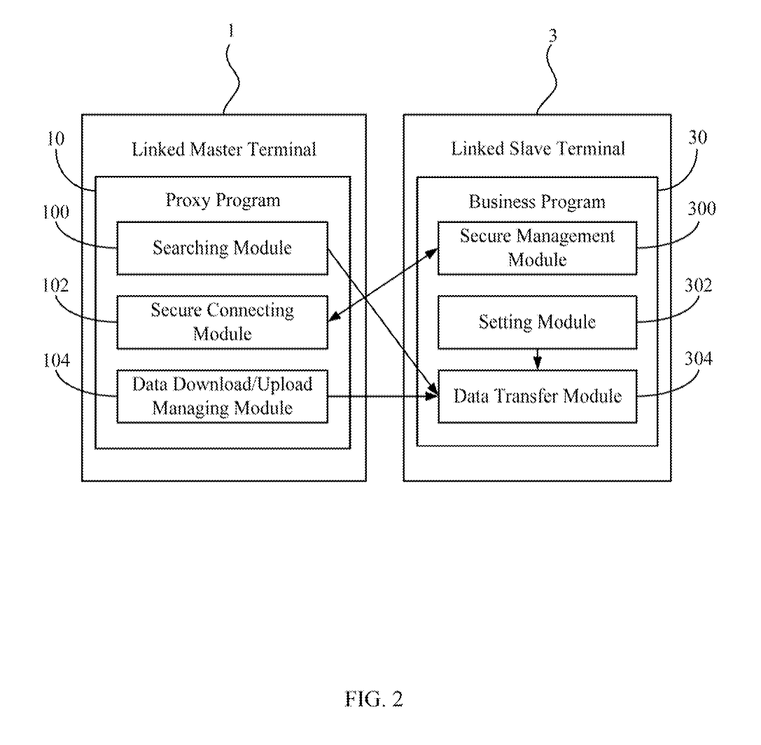

FIG. 2 is a schematic diagram of software function modules of the proxy program 10 and the business program 30 of FIG. 1. The proxy program 10 mainly includes a searching module 100, a secure connecting module 102, and a data download/upload managing module 104. The business program 30 mainly includes a secure management module 300, a setting module 302, and a data transfer module 304.

The searching module 100 is configured for searching one of the linked slave terminals 3 via the network 2 by utilizing a Web searching method. For example, in a same subnet, each of the linked slave terminals 3 has a media access control (MAC) address. The searching module 100 identifies a target slave terminal 3 from other linked slave terminals 3 by the MAC address.

The secure connecting module 102 is configured for establishing a secure connection between the target slave terminal 3 and the at least one linked master terminal 1 after the searching module 100 has searched the target slave terminal 3. The secure connection means that the secure management module 300 would verify whether a certificate authority (CA) of the at least one linked master terminal 1 is available. The at least one linked master terminal 1 can communicate with the target slave terminal 3 via a secure socket layer. In the preferred embodiment, the secure connecting module 102 establishes the secure connection through a user name and a password set in the at least one linked master terminal 1 or the target slave terminal 3. When a user wants to control or manage the target slave terminal 3 via the linked master terminal 1, the user needs to input the correct user name and password to the target slave terminal 3, and then the secure connection between the at least one linked master terminal 1 and the target slave terminal 3 is established.

The data download/upload managing module 104 is configured for sending a task request to the target slave terminal 3. The task request mainly includes a data download request, a data upload request, a task add request, and/or a task delete request.

The setting module 302 is configured for setting task parameters of the target slave terminal 3. The task parameters include the operating status, amount of tasks, an operating information record, and a disk volume status option of the target slave terminal 3. The operating status can be automatically updated/refreshed in real time, every half hour, hourly . . . etc. The operating information record includes a filename, a file size, a location of the file, the task request time or the task delete time. The disk volume status includes a data storage used space and a remaining space.

The data transfer module 304 is configured for sending a response message to the at least one linked master terminal 1 after the target slave terminal 3 has received the task request, downloading data from a remote server or uploading data to the remote server, reporting the progresses of the data downloads or the data uploads according to the operating status, and saving the downloaded data in a file.

The data transfer module 304 is further configured for adding tasks, deleting tasks, recording the operating information, and displaying the disk volume status of the target slave terminal 3 on the at least one linked master terminal 1.

In the preferred embodiment, the searching module 100 is also configured for querying the data transfer speeds and the download/upload progresses of the target slave terminal 3.

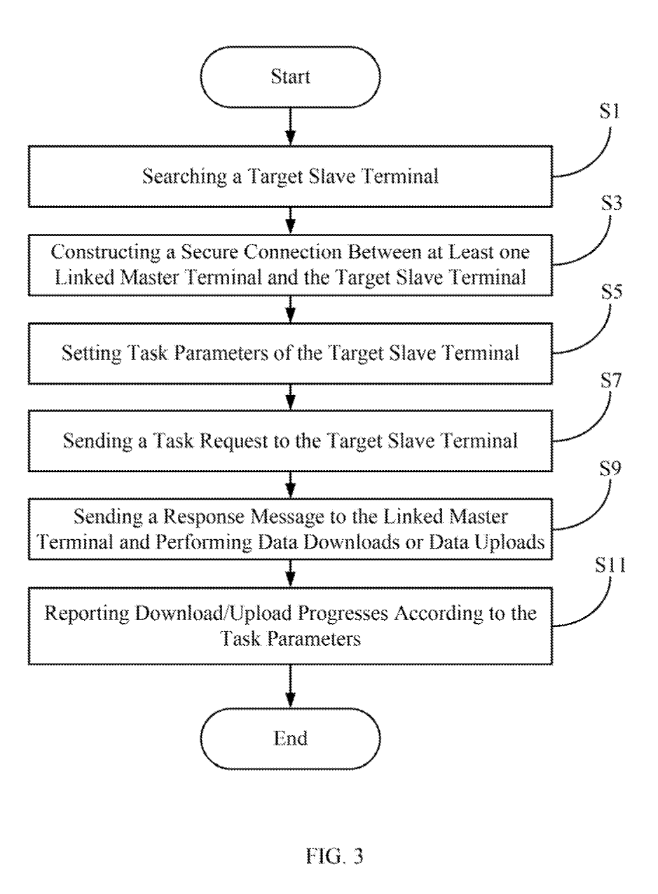

FIG. 3 is a flowchart of a preferred method for managing data downloads and data uploads in accordance with another embodiment. In step S1, the searching module 100 searches for the target slave terminal 3 from the linked slave terminals 3 in the same subnet, and identifies the target slave terminal 3 from other linked slave terminals 3 by the corresponding MAC address.

In step S3, the secure connecting module 102 establishes a secure connection between the linked master terminal 1 and the target slave terminal 3.

In step S5, a user sets the task parameters of the target slave terminal 3 via the setting module 302. The task parameters include the operating status, the amount of tasks, the operating information record and the disk volume status option.

In step S7, the data download/upload managing module 104 sends the task request to the target slave terminal 3 via the network 2. The task request includes the data download request, the data upload request, the task add request, and/or the task delete request. The data transfer module 304 adds tasks or deletes tasks according to the task parameters. In step S7, the searching module 100 can query the data transfer speeds or the download/upload progresses of the target slave terminal 3.

In step S9, the data transfer module 304 receives the task request and sends the response message to the at least one linked master terminal 1 in order to inform the user that the target slave terminal 3 has received the task request, and the data transfer module 304 performs the process of data downloads or data uploads, namely downloading data from a remote server or uploading data to the remote server.

In step S11, the data transfer module 304 reports the download/upload progresses to the linked master terminal 1 according to the operating status, and saves the downloaded data in the file. For example, the data transfer module 304 sends an email to the at least one linked master terminal 1 via the network 2. The data transfer module 304 records the filename, the file size and the location of the file, and displays the disk volume status of the target slave terminal 3 in the at least one linked master terminal 1, such as displaying “data storage used space” and “remaining space” of the target slave terminal 3. In the preferred embodiment, the data transfer module 304 also can report the data transfer speeds and the download/upload progresses of the target slave terminal 3 to the linked master terminal 1.

In the other embodiment, the user also can set the operating status in one step that is between the step S3 and the step S11.

It is to be understood, however, that even though numerous characteristics and advantages of the indicated invention have been set forth in the foregoing description, together with details of the structure and function of the invention, the disclosure is illustrative only and changes may be made in details, especially in matters of shape, size and arrangement of parts within the principles of the invention to the full extent indicated by the broad general meaning of the terms in which the appended claims are expressed.

What is claimed is:

1. A system for managing data downloads and data uploads, the system comprising at least one linked master terminal, and a plurality of linked slave terminals connected to the at least one linked master terminal via a network, wherein:
the at least one linked master terminal is configured with a proxy program, which comprises:
a searching module configured for searching one of the linked slave terminals via the network, and identifying a target slave terminal from other linked slave terminals by a MAC address;
a secure connecting module configured for establishing a secure connection between the target slave terminal and the at least one linked master terminal; and
a data download/upload managing module configured for sending a task request to the target slave terminal, the task request comprising a data download request and a data upload request; and
the target slave terminal is configured with a business program, which comprises:
a setting module configured for setting task parameters of the target slave terminal, the task parameters comprising an operating status; and
a data transfer module configured for performing data downloads or data uploads according to the task request, reporting download/upload progresses according to the operating status, and saving downloaded data in a file.

2. The system for managing data downloads and data uploads as described in claim 1, wherein the task parameters further comprise an operating information record and a disk volume status option of the target slave terminal, the operating information comprising a filename, a file size and a location of the file.

3. The system for managing data downloads and data uploads as described in claim 2, wherein the data transfer module is further configured for sending a response message to the at least one linked master terminal after receiving the task request, recording the filename, the file size and the location of the file, and displaying the disk volume status of the target slave terminal on the at least one linked master terminal.

4. The system for managing data downloads and data uploads as described in claim 1, wherein the searching module is further configured for querying data transfer speeds or the download/upload progresses of the target slave terminal.

5. The system for managing data downloads and data uploads as described in claim 1, wherein the task request further comprises a task add request, and/or a task delete request.

6. A computer-enabled method for managing data downloads and data uploads, the method comprising:
providing at least one linked master terminal connecting with a plurality of linked slave terminals via a network;
searching one of the linked slave terminals, and identifying a target slave terminal from other linked slave terminals by a MAC address;
establishing a secure connection between the at least one linked master terminal and the target slave terminal;
setting task parameters of the target slave terminal through the at least one linked master terminal, the task parameters comprising an operating status;
sending a task request to the target slave terminal, the task request comprising a data download request and a data upload request;
performing data downloads or data uploads according to the task request from the at least one linked master terminal;
reporting download/upload progresses of the target slave terminal to the linked master terminal according to the operating status; and
saving downloaded data in a file.

7. The method for managing data downloads and data uploads as described in claim 6, wherein the task request further comprises a task add request, and/or a task delete request.

8. The method for managing data downloads and data uploads as described in claim 6, further comprising a step after the step performing data download or data upload:
querying data transfer speeds and the download/upload progresses of the target slave terminal by the at least one linked master terminal.

9. The method for managing data downloads and data uploads as described in claim 6, wherein the task parameters further comprise an operating information record and a disk volume status option of the target slave terminal, the operating information comprising a filename, a file size and a location of the file.

10. The method for managing data downloads and data uploads as described in claim 9, further comprising steps of:
recording the filename, the file size, and the location of the file; and
displaying the disk volume status of the target slave terminal on the at least one linked master terminal.
